(19) United States
(12) Patent Application Publication
(10) Pub. No.: US 2005/0118922 A1
(43) Pub. Date: Jun. 2, 2005

(54) Touch panel and method for manufacturing the same

(75) Inventor: Michiko Endo, Shinagawa (JP)

Correspondence Address: STAAS & HALSEY LLP, SUITE 700, 1201 NEW YORK AVENUE, N.W., WASHINGTON, DC, 20005, US

(73) Assignee: Fujitsu Component Limited, Tokyo (JP)

(21) Appl. No.: 10/943,913

(22) Filed: Sep. 20, 2004

(30) Foreign Application Priority Data
Nov. 27, 2003 (JP) 2003-397285
Apr. 16, 2004 (JP) 2004-121702

(51) Int. Cl. H01J 9/00; H01J 9/24

(52) U.S. Cl. 445/24

(57) ABSTRACT

The present invention relates to a resistive-film type touch panel using a transparent conductive polymer film as a transparent electrode film. The touch panel includes a transparent resin sheet and a glass substrate having an ITO film formed thereon. After a solution having a transparent conductive polymer dispersed in a solvent is applied to the undersurface of the transparent resin sheet, the solution is heated and dried in order to form a transparent conductive polymer film. The ITO film and transparent conductive polymer film serve as transparent electrode films that are opposed to each other. When the transparent resin sheet is pressed, the films touch each other. Consequently, a change in resistance corresponding to the pressed position can be detected.

### CROSS-REFERENCE TO RELATED APPLICATIONS

This application claims the priorities of Japanese Patent Application No. 2003-397285, filed on Nov. 27, 2003, and of Japanese Patent Application No. 2004-121702, filed on Apr. 16, 2004.

### BACKGROUND OF THE INVENTION

1. Field of the Invention

The present invention relates to a resistive-film type touch panel that can detect a change in resistance corresponding to a pressed position and a method for manufacturing the touch panel. More particularly, the present invention is concerned with a resistive-film type touch panel that does not require large manufacturing equipment but makes it possible to adopt a simple technique of forming an electrode film so as to reduce the cost of manufacture, and a method of manufacturing the touch panel.

2. Description of the Related Art

Conventionally, touch panels are mounted on the screens of a cathode-ray tube serving as a display device, a flat-panel display connected to a personal computer, and others. A user uses a pen or his/her finger to write something on the touch panel or press the touch panel, whereby an input can be made on the screen of a display device. In recent years, the touch panel has been widely adapted to various pieces of equipment because of the convenience in making an input.

The conventionally adopted touch panel includes a resistive-film type touch panel. The resistive-film type touch panel has a layered structure as a whole, wherein a glass substrate on which a transparent electrode film is formed, and a transparent resin sheet on which a transparent electrode film is formed are layered with a plurality of dot spacers between them. The transparent electrode films are made from indium-tin-oxide (ITO) films.

The transparent electrode films adapted to conventional resistive-film type touch panels include, in addition to the ITO film, a thin film made of a metal oxide such as a tin oxide. The thin film is normally formed through a layering process such as sputtering or deposition, and has a thickness of, for example, several tens of nanometers.

On the other hand, in a general touch panel, an ITO film or any other thin film made of a metal oxide has been adopted as a transparent electrode film. A touch panel adopting a conductive polymer film as transparent electrode films instead of the thin film made of a metal oxide has been proposed. For example, Japanese Unexamined Patent Application Publication No. 61-204722 has disclosed that the conductive high polymer film is produced by making a polymer film conductive through chemical bonding. Alternatively, Japanese Unexamined Patent Application Publication No. 3-167590 has disclosed that the conductive polymer film can be produced by dispersing fine ITO particles or any other particles into a resin.

As mentioned above, the ITO film or any other thin film made of a metal oxide that has been adopted in the past is produced through a vacuum process such as sputtering or deposition. Therefore, even for production of transparent electrode films for touch panels, a large-scale facility is necessary. Consequently, the method is poor for the mass production of a touch panel.

Moreover, the ITO film or any other thin film made of a metal oxide that has been adopted as transparent electrode films in the past lacks flexibility and is therefore so susceptible, under bending or an impact, to crack easily. Therefore, when the thin film is employed in a touch panel, if a pen point or a fingertip is strongly pressed against a working surface and slid thereon for handwriting, a transparent electrode film may be cracked or damaged. Trouble may occur in the action of the touch panel and, for example, the precision in detecting a position may be degraded.

As a means for preventing occurrence of a crack or damage in a transparent electrode film, the adoption of the conductive polymer film as transparent electrode films to be included in a touch panel is known as described in the foregoing patent documents. In a touch panel described in Japanese Unexamined Patent Application Publication No. 61-204722, conductive electrodes formed on both upper and lower substrates are produced in the form of a stripe. The conductive electrodes on the upper substrate are coated with a conductive polymer having been made conductive. Moreover, in a touch panel described in Japanese Unexamined Patent Application Publication No. 3-167590, a conductive resin film having fine particles of ITO or the like dispersed in a resin is adopted as transparent electrode films. Transparent electrodes are separately formed on a plurality of regions on each surface of the substrates.

In the foregoing touch panels, occurrence of damage to a transparent electrode film may be minimized. However, as the touch panels are of a type having a plurality of transparent electrode films, it is time-consuming to produce the transparent electrode films. It is therefore hard to reduce the cost of manufacture. Moreover, there is difficulty in realizing concurrent multi-point input using a simple method.

Accordingly, an object of the present invention is to provide a touch panel of a resistive-film type and a touch panel manufacturing method, wherein a transparent electrode film is layered by applying a solution, which has a transparent conductive polymer dispersed in the solvent, all over the surface of a substrate, and then dried. Thus, the cost of manufacture is reduced. Moreover, mass production is enabled, and a concurrent multi-point input is readily realized.

### SUMMARY OF THE INVENTION

In order to solve the foregoing problems, according to the present invention, there is provided a touch panel that has first and second transparent electrode films formed on the internal surfaces of first and second substrates, which are opposed to each other, with a plurality of dot spacers between them, and that can detect a change in resistance corresponding to a pressed position. Herein, at least one of the first and second transparent electrode films is formed by coating the substrate with a transparent conductive polymer.

The first transparent electrode film may be realized with an ITO film, and the second transparent electrode film may be formed by layering the transparent conductive polymer. Alternatively, the first and second transparent electrode films may be formed by coating the substrate with the transparent conductive polymer.

Moreover, the first substrate may be made of a glass, and the second substrate may be made from a transparent resin sheet. Alternatively, the first and second substrates may be made from transparent resin sheets. Furthermore, a third substrate may be bonded to the external surface of the first or second substrate.

Moreover, the first or second transparent electrode film may be made from a transparent conductive polymer film layered all over one surface of the first or second substrate. Electrodes made from a conductive pattern or electrodes realized with a wiring pattern may be layered on the perimeter of the transparent conductive polymer film. Alternatively, the electrodes realized with the conductive pattern or the electrodes realized with the wiring pattern may be layered on the perimeter of one surface of the first or second substrate between the first or second substrate and the transparent conductive polymer film.

Furthermore, in the touch panel in accordance with the present invention, the first or second transparent electrode film is made from a laminated body composed of an ITO film and a transparent conductive polymer film.

Moreover, in the touch panel in accordance with the present invention, the transparent electrode film formed on at least one surface of the first or second substrate comprises transparent electrode films formed by coating a plurality of regions on the substrate with a transparent conductive polymer film. The electrode films on the plurality of regions can mutually independently detect a change in resistance corresponding to a pressed position. The transparent electrode films are separated from each other in parallel with one of the edges of the first or second substrate.

Moreover, in the touch panel in accordance with the present invention, the surface of the transparent conductive polymer film has microscopic irregularities.

Furthermore, according to the present invention, there is provided a touch panel that has first and second transparent electrode films formed on the internal sides of first and second substrates, which are opposed to each other, with a plurality of dot spacers between them, and that can detect a change in resistance corresponding to a pressed position. Herein, at least one of the first and second transparent electrode films is on the pressing side. The transparent electrode film serving as the film on the pressing side is made from an ITO film. A transparent conductive polymer film is formed on the perimeter of the transparent electrode film so that it will have a predetermined width.

Moreover, according to the present invention, there is provided a touch panel manufacturing method for producing a touch panel, which can detect a change in resistance corresponding to a pressed position, by opposing first and second substrates to each other with a plurality of dot spacers between them after forming first and second transparent electrode films on the internal surfaces of the first and second transparent substrates. Herein, at least one of the first and second transparent electrode films is layered by applying a transparent conductive polymer dispersed into a solvent to the surface of the substrate and then heating and drying it.

The first transparent electrode film may be formed on the internal side of the first substrate using an ITO film. The second transparent electrode film may be layered by applying the transparent conductive polymer dispersed into a solvent to the internal surface of the second substrate and then heating and drying it. Alternatively, the first transparent electrode film may be layered by applying the transparent conductive polymer, which is dispersed into a solvent, to the internal surface of the first substrate and then heating and drying it. The second transparent electrode film may be layered by applying the transparent conductive polymer, which is dispersed into a solvent, to the internal side of the second substrate, and then heating and drying it.

Furthermore, the application of the transparent conductive polymer to the substrate is performed on a predetermined region according to a pattern through printing. The first transparent electrode film may be formed on the surface of a glass substrate, and the second transparent electrode film may be formed on the surface of a transparent resin sheet. Alternatively, the first and second transparent electrodes are formed on the surfaces of transparent resin sheets.

Moreover, the first and second transparent electrodes may be layered by applying the transparent conductive polymer, which is dispersed in a solvent, to the surface of a continuous transparent resin sheet, and then heating and drying it. In this case, the transparent resin sheet is folded so that the first and second transparent electrode films will be opposed to each other with the dot spacers between them.

In the touch panel manufacturing method in accordance with the present invention, the first or second transparent electrode film may be layered coating the transparent conductive polymer. Thereafter, an electrode pattern or a wiring pattern may be formed on the perimeter of the first or second transparent electrode film. Alternatively, the electrode pattern or wiring pattern may be formed on the perimeter of the first or second substrate. Thereafter, the first or second transparent electrode film may be layered on the first or second substrate as well as on the electrode pattern or wiring pattern using the transparent conductive polymer.

Moreover, the first or second transparent electrode is formed by coating an ITO film formed on the first or second substrate with the transparent conductive polymer.

In the touch panel manufacturing method in accordance with the present invention, at least one of the first and second transparent electrode films comprises a plurality of separate electrode films formed by applying the transparent conductive polymer to a plurality of regions of the substrate.

Moreover, according to the present invention, the surface of the first or second transparent electrode film formed by coating the substrate with the transparent conductive polymer has microscopic irregularities. At least one of the first and second transparent electrode films may be layered by applying the transparent conductive polymer, which is dispersed in a solvent, to the surface of the substrate, then heating and drying the transparent conductive polymer with a plate, of which the surface is machined to have irregularities or to look like a mesh, superposed on the surface to which the transparent conductive polymer is applied, and then detaching the plate. Alternatively, at least one of the first and second transparent electrode films may be formed by applying a transparent conductive polymer and inorganic particles, which are dispersed in a solvent, to the surface of the substrate, and then heating and drying it, so that the surface of the electrode film will have microscopic irregularities.

According to the present invention, there is provided a touch panel manufacturing method for producing a touch panel, which can detect a change in resistance corresponding to a pressed position, by opposing first and second substrates to each other with a plurality of dot spacers between them after forming first and second transparent electrode films on the internal sides of the first and second substrates. At least one of the first and second transparent electrode films is formed on the substrate using an ITO film. After a transparent conductive polymer dispersed in a solvent is applied to the edges of the touch panel that have a predetermined width and correspond to the perimeter of the ITO film, the transparent conductive polymer is heated and dried.

According to the present invention, in a resistive-film type touch panel, a solution having a transparent conductive polymer dispersed in a solvent is applied to the surface of a substrate and then dried in order to form a transparent electrode film. A special transparent electrode film formation apparatus, such as a sputtering or deposition apparatus, is not needed. A simple technique that does not require alignment, such as screen printing, is adopted as a technique for applying the solution. This results in a reduction in the cost of manufacture of a touch panel.

Furthermore, as a transparent electrode film is formed using a transparent conductive polymer, occurrence of a damage in the transparent electrode film can be minimized. Consequently, a substrate on which a transparent electrode film is formed is not necessarily hard. Nevertheless, the capability of a touch panel can be fully exerted. Therefore, a transparent resin sheet can be adopted as a substrate. This leads to improved mass productivity and a reduced cost of manufacture of a touch panel.

Moreover, a transparent electrode film can be formed by applying and drying a solution of a transparent conductive polymer. This contributes to the expansion of the freedom to form a transparent electrode film on a substrate. Consequently, a plurality of separate transparent electrode films permitting concurrent multi-point entry can be formed easily. Furthermore, when a transparent electrode film is realized with an ITO film, a transparent conductive polymer film can be readily formed on the whole or part of the ITO film for the purpose of improving the durability to handwriting and the sliding smoothness.

Furthermore, when a transparent electrode film is formed on a substrate, a technique of applying a solution of a transparent conductive polymer and drying it is adopted. Microscopic irregularities can be readily formed on the surface of the electrode film in the course of drying. Thus, an anti-Newton's rings effect, that will prove effective when a touch panel is pressed, can be added.

### BRIEF DESCRIPTION OF THE DRAWINGS

Other features, objects, and advantages of the present invention will become apparent from the following description of preferred embodiments with reference to the drawings in which the same reference characters denotes the same or equivalent components throughout several drawings, and which:

FIG. 1 is a sectional view for explaining the structure of a first embodiment of a touch panel in accordance with the present invention;

FIG. 2 is a flowchart describing a procedure of manufacturing an upper substrate included in a touch panel in accordance with the first embodiment;

FIG. 3 is a graph indicating a change in linearity occurring when a conductive polymer is adopted as a transparent electrode and a change therein occurring when an ITO film is adopted as the transparent electrode;

FIG. 4 is a flowchart describing a variant of the procedure of manufacturing an upper substrate included in the touch panel in accordance with the first embodiment;

FIG. 5 is a sectional view for explaining the structure of a variant of the touch panel in accordance with the first embodiment;

FIG. 6 is a sectional view for explaining the structure of a second embodiment of the touch panel in accordance with the present invention;

FIG. 7 is a flowchart describing the procedure of manufacturing a touch panel in accordance with the second embodiment;

FIG. 8 is a sectional view for explaining the structure of a variant of the touch panel in accordance with the second embodiment;

FIG. 9 is a sectional view for explaining the structure of a third embodiment of the touch panel in accordance with the present invention;

FIG. 10 is a flowchart describing a procedure of manufacturing a touch panel in accordance with the third embodiment;

FIG. 11 is a sectional view for explaining the structure of a variant of the touch panel in accordance with the third embodiment;

FIG. 12 is an explanatory diagram showing the structure of a touch panel that conforms to the principles of the present invention and that serves as the fundamentals of a touch panel in accordance with a fourth embodiment;

FIG. 13 is a sectional view for explaining the structure of the touch panel in accordance with the fourth embodiment of the present invention;

FIG. 14 is a flowchart describing the procedure of manufacturing the touch panel in accordance with the fourth embodiment;

FIG. 15A and FIG. 15B are enlarged sectional views showing the structure of a major portion of a fifth embodiment of the touch panel in accordance with the present invention;

FIG. 16 is a flowchart describing the procedure of manufacturing a touch panel in accordance with the fifth embodiment; and

FIG. 17 is a sectional view showing the structure of a touch panel in accordance with a related art.

### DESCRIPTION OF THE PREFERRED EMBODIMENTS

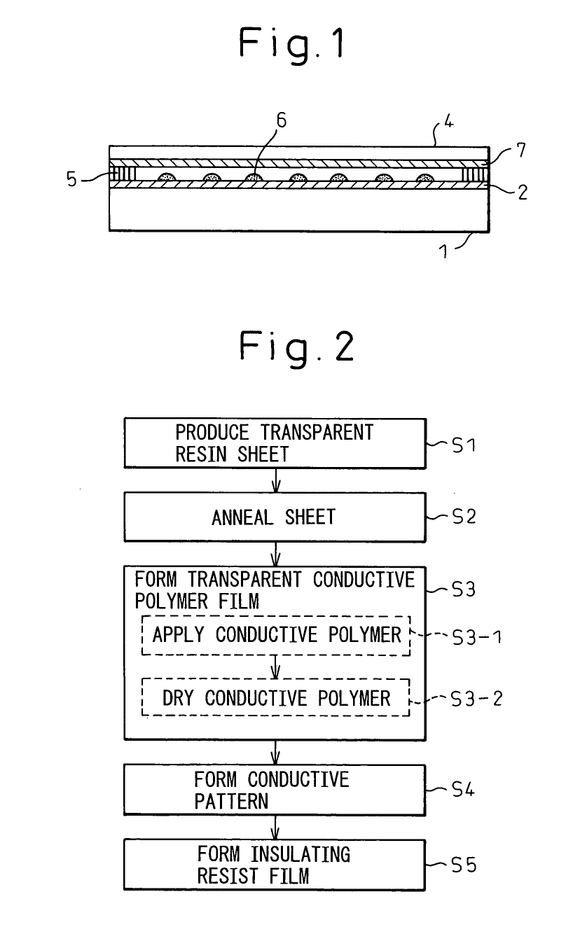

Referring to the drawings, embodiments of a resistive-film type touch panel and a touch panel manufacturing method in which the present invention is implemented will be described below. To begin with, prior to the description of the resistive-film type touch panels and touch panel manufacturing methods in accordance with the embodiments, the structure of a resistive-film type touch panel in accordance with a related art which serves as the fundamentals of the embodiments will be described, with reference to FIG. 1, for the purpose of distinguishing the features and advantages of the embodiments.

FIG. 17 is a sectional view showing a resistive-film type touch panel that has been employed in the past. In FIG. 17, the fundamental structure of the touch panel is illustrated schematically. For a better understanding, the structure is illustrated with exaggeration. The touch panel comprises a glass substrate 1, transparent electrode films 2 and 3, a transparent resin sheet 4, a spacer 5, and a plurality of dot spacers 6, and has a layered structure as a whole.

The transparent electrode film 2 made from an ITO film is formed on the glass substrate 1. The plurality of dot spacers 6 is disposed on the transparent electrode film 6 with an appropriate spacing between adjoining dot spacers. The spacer 5 is disposed on the peripheral part of the surface of the glass substrate 1. The transparent resin sheet 4 having the transparent electrode film 3 formed thereon using an ITO film is superposed on the transparent electrode film 2 with the spacer 5 between them. The transparent resin sheet 4 serves as a cover sheet of the touch panel and also serves as a contact surface to be pressed with a finger or an input pen that is not shown.

Normally, touch panels have rectangular shapes. An electrode pattern is formed along each of the four edges of a touch panel. An ITO film adopted as transparent electrode films has a resistivity which is determined in order to optimize an amount of used power and a degree of precision in detecting a position. When the touch panel is pushed by a finger or a pen, the transparent resin sheet 4 warps at a pressed position, and the transparent electrode film 3 touches the transparent electrode film 2 between the dot spacers 6 adjoining at the position. At this time, a voltage is applied to two electrode patterns that are opposed to each other in the direction of an X axis, whereby a resistance associated with a point on the X axis is detected. Furthermore, a voltage is applied to two electrode patterns opposed to each other in the direction of a Y axis instead of the two electrode patterns opposed to each other in the X-axis direction, whereby a resistance associated with a point on the Y axis is detected. In the resistive-film type touch panel, coordinates representing the pressed position are thus detected.

As mentioned above, the touch panel in accordance with the related art adopts an ITO film as transparent electrode films. According to the present invention, there are provided a touch panel and a touch panel manufacturing method in which: a touch panel is designed to be of a resistive-film type; and transparent electrode films included in the touch panel are layered by applying a solution, which has a transparent conductive polymer dispersed in a solvent, to the whole surface of a substrate and then drying the solution. Thus, the cost of manufacture is reduced, and mass production is enabled. Moreover, concurrent multi-point entry can be readily realized.

Next, embodiments of a resistive-film type touch panel in which the present invention is implemented will be described with reference to FIG. 1 to FIG. 16. The embodiments of the resistive-film type touch panel include first to fifth embodiments that are different from one another in terms of the structure of a touch panel.

The first embodiment adopts a transparent resin sheet coated with a transparent conductive polymer as an upper substrate. The second embodiment adopts the transparent resin sheet coated with the transparent conductive polymer as both the upper and lower substrates of a touch panel. The third embodiment adopts as the upper substrate the transparent resin sheet coated with an ITO film and the transparent conductive polymer. The fourth embodiment adopts as the upper substrate the transparent resin sheet having a plurality of regions thereof coated with the transparent conductive polymer. The fifth embodiment adopts the transparent resin sheet whose surface is roughed to have irregularities and coated with the transparent conductive polymer.

### First Embodiment

FIG. 1 is a sectional view of a resistive-film type touch panel in accordance with the first embodiment of the present invention. The first embodiment to be described below adopts as an upper substrate a transparent resin sheet coated with a transparent conductive polymer. The fundamental structure of the resistive-film type touch panel shown in FIG. 1 is identical to that of the resistive-film type touch panel shown in FIG. 17. The same reference numerals are assigned to identical components. The structure of the touch panel in accordance with the first embodiment is different from the structure of the conventional touch panel shown in FIG. 17 in a point that although a transparent electrode film formed on the undersurface of the transparent resin sheet 4 included in the conventional touch panel is made from the ITO film 3, the transparent electrode film included in the touch panel in accordance with the first embodiment is made from a transparent conductive polymer film 7 but not with the ITO film 3. This point is the feature of the first embodiment.

Referring to FIG. 1, a transparent electrode film is formed on a glass substrate 1 using an ITO film 2. A plurality of dot spacers 6 is disposed on the ITO film. An upper substrate is realized with a flexible transparent resin sheet 4 made of, for example, PET, polycarbonate, or cycloolefin. A transparent electrode film made of a thiophene conductive polymer is formed on the transparent resin sheet 4. The thiophene conductive polymer exhibits high transparency. When the thickness of the thiophene conductive polymer is about 500 nm, the optical transmittance thereof is 90% or more. The transparent electrode film is not limited to the thiophene conductive polymer but polyaniline or any other material may be adopted as a transparent conductive polymer.

Referring to FIG. 2, the procedure of manufacturing the resistive-film type touch panel shown in FIG. 1 will be described below. The difference of the structure of the touch panel shown in FIG. 1 from that of the conventional touch panel lies in the transparent conductive polymer film 7 formed as a transparent electrode film on the transparent resin sheet 4. The ITO film 2 formed on the glass substrate 1 is identical to that included in the conventional touch panel. The flowchart of FIG. 2 describes only the procedure for forming the transparent conductive polymer film 7. The procedure for forming the ITO film 2 will be omitted and not be described.

Referring to FIG. 2, first, a transparent resin sheet made of PET, polycarbonate, or cycloolefin is cut in the size of a work (step S1). The cut transparent resin sheet is annealed in order to nullify the deformation thereof (step S2).

Thereafter, a transparent conductive polymer film is formed on the annealed transparent resin sheet (step S3). More particularly, a solution having a transparent conductive polymer dispersed therein is applied to a predetermined region on the transparent resin sheet (step S3-1) through screen printing. Thus, the transparent resin sheet is patterned using the solution. After the solution is heated and dried, the transparent conductive polymer film is layered on the transparent resin sheet (step S3-2).

A conductive pattern serving as electrodes via which a voltage for detecting positions is applied to the transparent conductive polymer film is formed along each of the opposed edges of the transparent resin sheet having the transparent conductive polymer film formed on the surface thereof (step S4). For formation of the conductive pattern, screen printing using a silver (Ag) paste as conventionally may be adopted.

Thereafter, an insulating resist film is formed through screen printing or the like in order to insulate the formed conductive pattern alone (step S5). Thus, the upper substrate for a touch panel is completed using the transparent resin sheet.

The lower substrate for a touch panel is produced concurrently with the foregoing process according to a different procedure. For the lower substrate, an ITO film is formed on a glass substrate, and dot spacers and a conductive pattern serving as electrodes are formed on the ITO film. An insulating resist film is then formed on the conductive pattern. After the upper substrate is completed, the upper and lower substrates are opposed to each other so that the transparent conductive polymer film and ITO film will become internal layers. The perimeters of the upper and lower substrates are bonded using a double-sided adhesive tape. A flexible printed-circuit board is coupled to each of the conductive patterns formed on the substrates. Finally, the touch panel is completed.

According to the flowchart of FIG. 2, after a transparent resin sheet is cut in the size of a work, a conductive polymer film is formed. Alternatively, a thiophene conductive polymer solution may be continuously applied to a roll of PET film using a micro-gravure coating apparatus. In this case, the solution on the roll of PET film is continuously heated and dried.

In reality, a transparent conductive polymer film having a thickness of approximately 0.1 μm has been formed according to the above technique. The total light transmittance of the transparent conductive polymer film is approximately 92%, and the sheet resistance thereof ranges from 1 kΩ/cm² to 2 kΩ/cm². For production of a touch panel, a procedure different from the one described in the flowchart of FIG. 2 will be followed. After a transparent resin sheet having the transparent conductive polymer film is formed thereon is cut in a desired size, the transparent resin sheet is annealed. Thereafter, an electrode pattern or a wiring pattern is printed using an Ag paste. On the other hand, as a lower substrate, a glass substrate coated with an ITO is adopted. The lower substrate is produced according to the same procedure as that included in a conventional touch panel. The perimeter of the transparent resin sheet serving as an upper substrate and the perimeter of the glass substrate are bonded to each other using a double-sided adhesive tape. A leader line realized with a flexible printed-circuit board is coupled to the electrode patterns. Thus, a touch panel is completed.

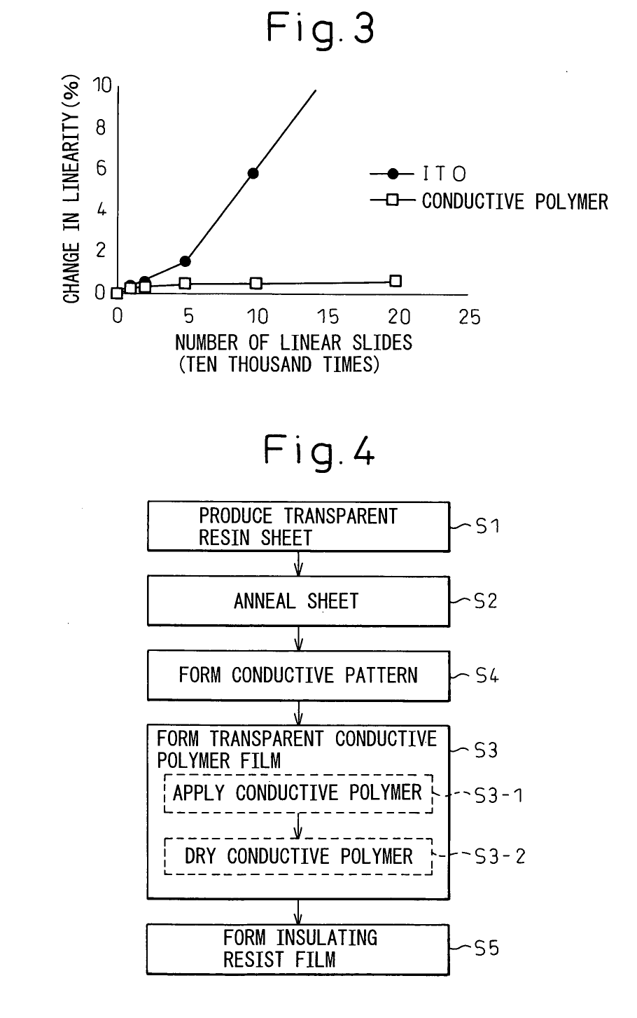

FIG. 3 shows the sliding characteristic of the transparent conductive polymer film employed in the touch panel in accordance with the first embodiment, which implies the durability thereof, in comparison with the sliding characteristic of a conventional ITO film. In the graph of FIG. 3, the axis of abscissas indicates the number of linear slides made by a plastic pen, and the axis of ordinates indicates a change in linearity equivalent to an error in detecting a position.

As seen from the graph of FIG. 3, the touch panel in accordance with the present embodiment is superior in durability to sliding. For example, assuming that a plastic pen which imposes a load of 500 g and whose pen point has a radius of 0.8 is slid back and forth, the service life of the touch panel in accordance with the present embodiment is five or more times longer than that of a touch panel employing an ITO film. The touch panel employing the ITO film exhibits a change in linearity in an early stage compared with the touch panel employing the conductive polymer film does. This signifies that deterioration of the touch panel employing the ITO film occurs earlier.

In the aforesaid resistive-film type touch panel in accordance with the first embodiment, as shown in FIG. 1, the transparent conductive polymer film 7 serving as a transparent electrode film is formed on the surface of the transparent resin sheet 4. In FIG. 1, a conductive pattern required for a touch panel, such as, an electrode or wiring pattern via which a voltage for detecting positions is applied to the transparent conductive polymer film is not shown. In reality, the conductive pattern is formed in a frame-like band portion in the perimeter of the touch panel so that it will surround a press or touch sensing region.

The flowchart of FIG. 2 describes a procedure of manufacturing a resistive-film type touch panel having the structure shown in FIG. 1. According to the manufacturing procedure, a conductive pattern is formed after the conductive polymer film 7 is layered on the surface of the transparent resin sheet 4. An insulating resist film is formed on the conductive pattern, whereby the conductive pattern is insulated.

When the conductive pattern is formed through screen printing using, for example, an Ag paste, as Ag is prone to migration, the insulating paste applied to the conductive pattern may be pierced. This degrades the insulation. As a structure capable of suppressing the degradation of insulation despite the migration, the insulating resist is not directly applied to the conductive pattern but is applied thereto with a transparent conductive polymer film between them.

The flowchart of FIG. 4 describes the procedure of manufacturing a resistive-film type touch panel, which can suppress degradation of insulation, in accordance with a variant. The manufacturing procedure is based on the one described in the flowchart of FIG. 2. The same reference numerals are assigned to identical steps.

The procedure of manufacturing a resistive-film type touch panel in accordance with the variant described in FIG. 4 is different from the manufacturing procedure described in FIG. 2 in a point that step S4 of forming a conductive pattern is inserted between step S2 of annealing and step S3 of forming a transparent conductive polymer film.

According to the resistive-film type touch panel manufacturing procedure described in FIG. 4, a conductive pattern formed on the transparent resin sheet 4 in the frame-like perimeter of the touch panel is covered with the transparent conductive polymer film 7, and further coated with an insulating resist. Even if migration of Ag takes place, as the transparent conductive polymer film intervenes, the insulating resist film will not be pierced. Degradation of insulation can thus be prevented.

In the aforesaid resistive-film type touch panel in accordance with the first embodiment, an ITO film is adopted as a transparent electrode film formed on a glass substrate serving as a lower substrate. FIG. 4 shows a variant of the resistive-film type touch panel in accordance with the first embodiment. In a resistive-film type touch panel in accordance with the variant, the ITO film serving as the transparent electrode film formed on the lower substrate is replaced with the transparent conductive polymer film.

As the ITO film is replaced with the transparent conductive polymer film, a sputtering or deposition apparatus that is used to form the ITO film need not be included in manufacturing equipment. For formation of a transparent conductive polymer film on a glass substrate, a simple technique of applying a solution, in which a transparent conductive polymer is dispersed, through screen printing and heating and drying the solution can be employed. Throughout the touch panel manufacturing procedure, low costs are attained.

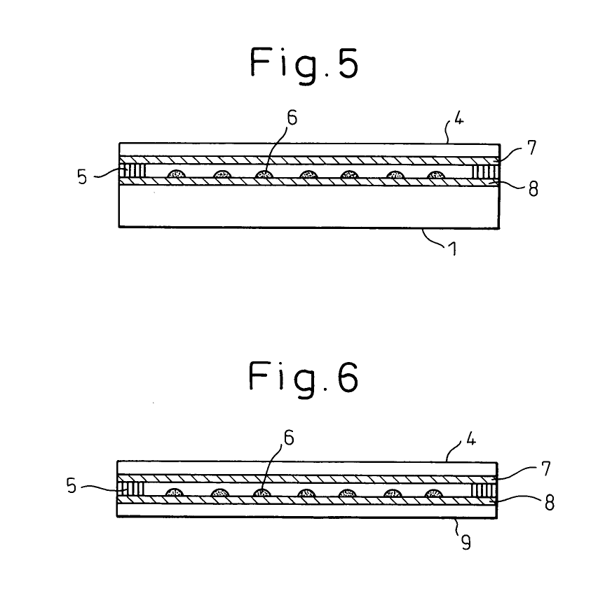

The structure of a resistive-film type touch panel shown in FIG. 5 is identical to that of the resistive-film type touch panel shown in FIG. 1. However, an ITO film 2 formed on a glass substrate 1 is replaced with a transparent conductive polymer film 8. For formation of the transparent polymer film, the transparent conductive electrode formation procedure described in FIG. 2 is employed. For production of a lower substrate, as a plurality of dot spacers is placed on the transparent electrode film, a dot spacer formation step is inserted between step S3 of forming a transparent conductive polymer film described in FIG. 2 and step S4 of forming a conductive pattern. The entire touch panel manufacturing procedure, except for the formation step, is identical to the procedure of manufacturing the resistive-film type touch panel shown in FIG. 1.

### Second Embodiment

In the resistive-film type touch panel in accordance with the first embodiment, a glass substrate is adopted as a lower substrate. In the second embodiment, a transparent resin sheet adopted as an upper substrate is also adopted as a lower substrate so that an entire touch panel will be flexible. The touch panel can be installed while being curved. Thus, the usefulness of the touch panel is intensified, the mass productivity thereof is improved, and the cost of manufacture is reduced.

FIG. 6 shows the structure of a resistive-film type touch panel in accordance with the second embodiment. In the structure, similarly to the structure of the resistive-film type touch panel shown in FIG. 5, transparent conductive polymer films 7 and 8 are adopted as transparent electrode films formed on upper and lower substrates respectively. However, a transparent resin sheet 9 is adopted as the lower substrate on behalf of a glass substrate 1. Consequently, the same substrate can be used as the upper and lower substrates. The upper and lower substrates can be manufactured using the same production line. Therefore, the touch panel can be readily mass-produced. Eventually, the cost of manufacture is reduced.

For mass production of a conventional ITO film, a rolled plastic sheet is continuously coated with an ITO through sputtering or vacuum deposition. The sputtering and vacuum deposition apparatuses are very large, and the coating time is long. Therefore, both sputtering and vacuum deposition are poor in mass productivity and the cost is high. In contrast, according to the present embodiment, a transparent conductive polymer film is formed using a solution in which a transparent conductive polymer is dispersed. Therefore, a blade coater, a roll coater, a printer, or any other relatively simple apparatus is used to apply a dispersed solution to the surface of a sheet, and then dry the solution. The coating time is short and the cost is much lower than the cost of production of an ITO film.

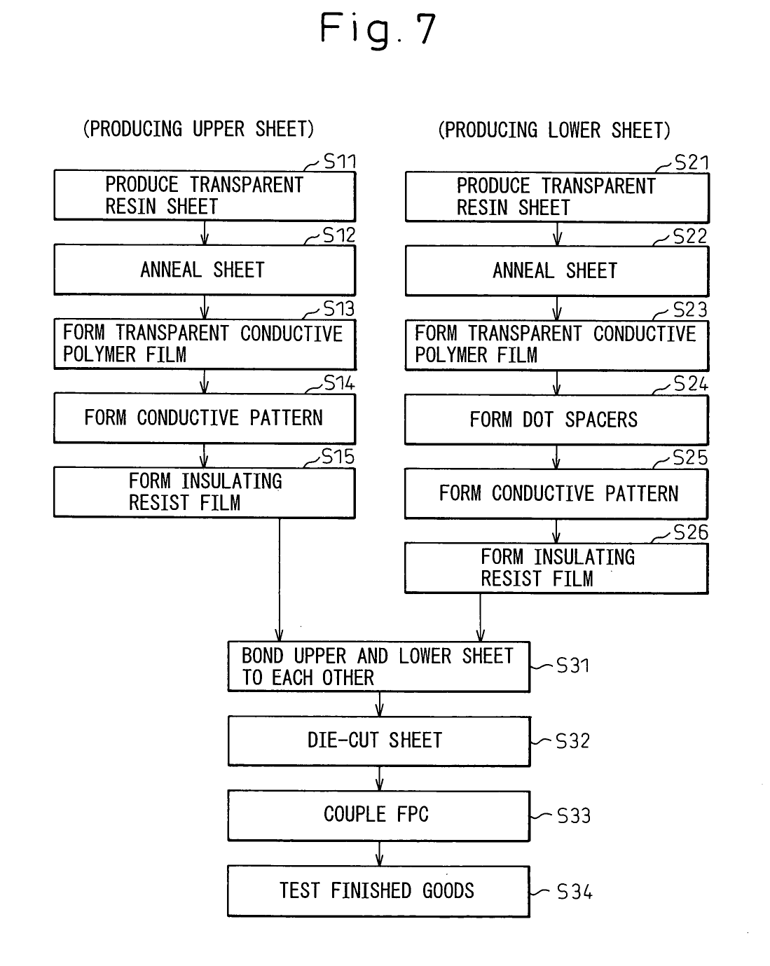

FIG. 7 is a flowchart outlining the process of manufacturing the resistive-film type touch panel shown in FIG. 6. According to the flowchart, the initial stage is divided into a stage of forming an upper sheet serving as an upper substrate and a stage of forming a lower sheet serving as a lower substrate. Although the structures of the upper and lower substrates are fundamentally the same, as dot spacers are placed on the lower substrate, a step of forming the dot spacers is added.

In the flowchart of FIG. 7, first, a transparent resin sheet made of PET, polycarbonate, or cycloolefin is cut in the size of a work for both the upper and lower substrates (steps S11 and S21). The cut transparent resin sheets are annealed (step S12 and S22).

Thereafter, a solution in which a transparent conductive polymer is dispersed is applied to a predetermined region on each of the transparent resin sheets 4 and 9 in order to form a pattern through screen printing, and then heated and dried. Thus, transparent conductive polymer films are produced (steps S13 and S23). These steps are identical to step S3 of forming a transparent conductive polymer film described in FIG. 2.

For production of the upper sheet, after the transparent conductive polymer film is formed, a conductive pattern serving as an electrode is formed (step S14). For formation of the lower sheet, after dot spacers are formed on the transparent conductive polymer film (step S24), a conductive pattern serving as electrodes is formed (step S25).

An insulating resist is applied to the formed conductive patterns (step S15 and S26). Thus, the upper and lower substrates are completed. Thereafter, the perimeters of the upper and lower substrates are bonded to each other using a double-sided adhesive tape so that the transparent conductive polymer film formed on the upper substrate and the transparent conductive polymer film formed on the lower substrate will be opposed to each other (step S31).

Thereafter, the bonded and layered upper and lower substrates are die-cut to have a predetermined size (step S32). A flexible printed-circuit board is coupled to the electrodes realized with the conductive patterns formed on the respective sheets, whereby a resistive-film type touch panel is completed (step S33). The finished touch panel is tested and then delivered (step S34).

When a conventional ITO film is employed, before an electrode pattern is printed, printing of an insulating pattern or etching of an ITO film must be performed without fail in order to remove an unnecessary ITO film portion. According to the foregoing manufacturing procedure employed in the present embodiment, a conductive pattern is printed in a required region alone from the beginning. The step of removing the unnecessary ITO film portion can therefore be omitted. This leads to a simplified manufacturing process.

In the resistive-film type touch panel manufacturing process described in FIG. 7, the upper and lower sheets may be produced from one mother sheet. In this case, a solution is applied to each of a portion of a transparent resin sheet having the size of a work which corresponds to an upper sheet and a portion thereof corresponding to a lower sheet, and then heated and dried. Thus, transparent conductive polymer films may be produced.

After dot spacers are formed on the portion corresponding to the lower sheet, the portions corresponding to the upper and lower sheets as well as coupling portions that join the respective portions and are folded, are die-cut. Thereafter, the die-cut coupling portions are folded. The portions corresponding to the upper and lower sheets are opposed to each other, and the perimeters thereof are bonded to each other. The adoption of this technique simplifies a manufacturing process and realizes a low cost.

The aforesaid resistive-film type touch panel has, as shown in FIG. 6, the upper and lower substrates thereof realized with transparent resin sheets. The entire touch panel is therefore flexible. Needless to say, the touch panel can be used as a unit. When the flexibility is utilized, the touch panel can be bonded to, for example, a curved display surface. Moreover, the touch panel can be bonded to a hard base.

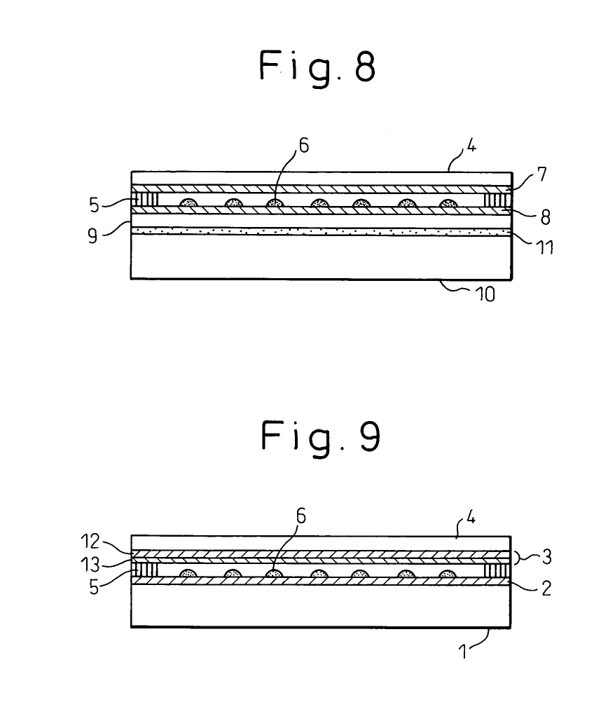

FIG. 8 shows a variant of the resistive-film type touch panel in accordance with the second embodiment. A resistive-film type touch panel shown in FIG. 8 has the same structure as the touch panel shown in FIG. 6. According to the present variant, the touch panel is flexible while having transparent conductive polymer films 7 and 8 formed on respective transparent resin sheets 4 and 9 serving as the upper and lower substrates. The touch panel of the second embodiment having a sheet-sheet type structure may be bonded to a display screen of an LCD or the like using a transparent adhesive. As shown in FIG. 8, the rear side of the transparent resin sheet 9 serving as the lower substrate may be bonded to a supporting plastic base 10 with a transparent adhesive layer 11 between them. The resultant touch panel may be superposed on the display screen in the same manner as a conventional touch panel having a film-glass type structure would be.

### Third Embodiment

A third embodiment is a resistive-film type touch panel in which a transparent resin sheet produced by laminating an ITO film and a transparent conductive polymer is adopted as a transparent electrode film. The fact that a conductive polymer film produced by applying a solution of a transparent conductive polymer and drying the solution is superior in sliding smoothness has been described in conjunction with FIG. 3. The third embodiment utilizes the fact that a transparent conductive film is made of a polymer in an effort to suppress degradation of the linearity in a touch panel occurring when an ITO film is adopted as a transparent electrode film.

FIG. 9 is a sectional view showing the structure of a resistive-film type touch panel in accordance with the third embodiment. The resistive-film type touch panel shown in FIG. 9 is based on the conventionally adopted resistive-film type touch panel shown in FIG. 17. The same reference numerals are assigned to identical components. The touch panel comprises a glass substrate 1, transparent electrode films 2 and 3, a transparent resin sheet 4, a spacer 5, and a plurality of dot spacers 6, and has a layered structure as a whole.

The touch panel of the third embodiment and the touch panel shown in FIG. 17 are identical to each other in the point that an ITO film is adopted as the transparent electrode film 2 formed on the glass substrate 1. However, in the touch panel of the third embodiment, the transparent electrode film 3 formed on the transparent resin sheet 4 has a transparent conductive polymer 13 layered on an ITO film 12 thereof.

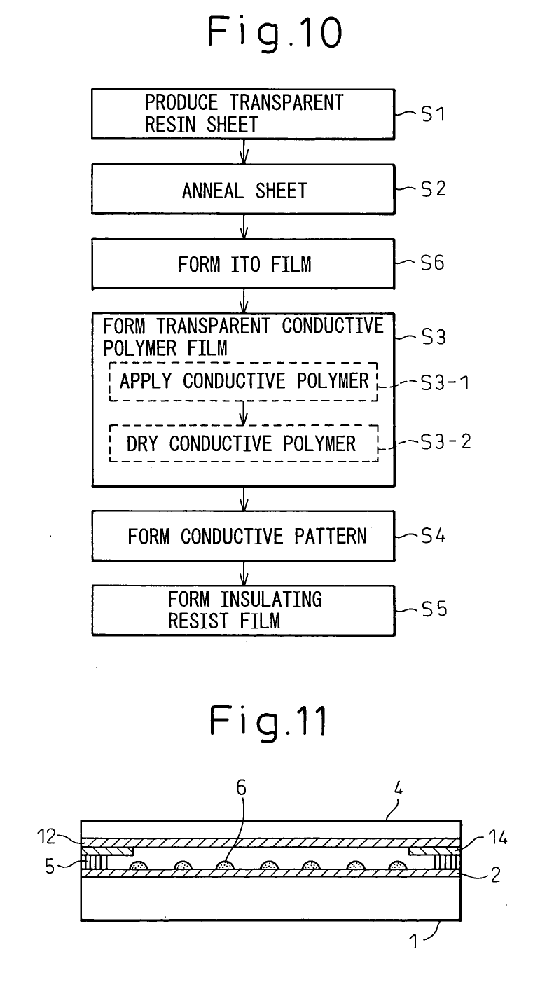

FIG. 10 is a flowchart describing a procedure of manufacturing the resistive-film type touch panel of the third embodiment. According to the third embodiment, a technique of applying a solution of a transparent conductive polymer and then heating and drying the solution is adopted in order to produce a transparent conductive polymer film. Therefore, the procedure of manufacturing the resistive-film type touch panel of the first embodiment can be adopted as a basis. In the flowchart of FIG. 10 describing the manufacturing procedure, the same reference numerals are assigned to steps identical to those in the flowchart of FIG. 2.

In the touch panel of the first embodiment, a transparent conductive polymer film is layered on the transparent resin sheet 4. In the third embodiment, the transparent conductive polymer film is layered on the whole surface of the ITO film 12 formed all over the transparent resin sheet 4. In the manufacturing procedure described in FIG. 10, an ITO film formation step (step S6) precedes a transparent conductive polymer film formation step (step S3). Herein, the procedure of layering the transparent conductive polymer film 13 is identical to that described in FIG. 2. However, in the third embodiment, the thickness of the layer is smaller than that required when the transparent conductive polymer film alone is layered on the transparent resin sheet.

As mentioned above, the transparent conductive polymer film 13 is layered all over the ITO film 12. Consequently, even if the ITO film formed on a press or touch sensing region is cracked or damaged, the transparent conductive polymer film maintains electrical conduction. The linearity of the touch panel will not be adversely affected, and the sliding characteristic thereof can be improved. Moreover, in this case, the brightness of the touch panel is higher than that attained when a transparent electrode film is realized with the transparent conductive polymer film alone.

In the foregoing third embodiment, the transparent conductive polymer film 13 is layered all over the ITO film 12 formed on the transparent resin sheet 4. Consequently, the sliding characteristics of the touch panel has improved. However, when the ITO film is adopted as a transparent electrode film, a place at which a crack or any other damage is likely to occur, with a press or a touch, is concentrated on the vicinity of the margin of the sensing region on the touch panel.

A variant of the third embodiment takes account of the fact that a crack or any other damage is likely to occur in the vicinity of the margin of the sensing region on the touch panel. A transparent conductive polymer film is not layered all over an ITO film but is layered only in the vicinity of the margin of the sensing region. FIG. 11 is a sectional view of a touch panel structured as mentioned above. The structure of the touch panel is identical to that of the touch panel shown in FIG. 9 except that a transparent conductive polymer 14 is layered on only the perimeter of an ITO film 12 in the form of a frame.

The procedure of manufacturing the resistive-film type touch panel in accordance with the variant of the third embodiment is identical to the manufacturing procedure described in the flowchart of FIG. 10. However, at step S3 of forming a transparent conductive polymer film, a solution of a transparent conductive polymer is not applied to the whole surface of the ITO film but applied only to the perimeter of the ITO film 12, in the form of a frame, through screen printing or the like.

As mentioned above, a transparent conductive polymer film is layered on only the perimeter of the ITO film 12 in the form of a frame. Even if the occurrence of cracks or any other damage is concentrated at the margin of the sensing region, the electrical conduction at the margin thereof can be maintained due to the presence of the transparent conductive polymer film.

### Fourth Embodiment

According to the foregoing first to third embodiments, one continuous transparent electrode film is formed using a transparent conductive polymer. According to the fourth embodiment, there is provided a resistive-film type touch panel adopting as an upper substrate a transparent resin sheet that has transparent conductive electrode polymer films formed in a plurality of regions thereof.

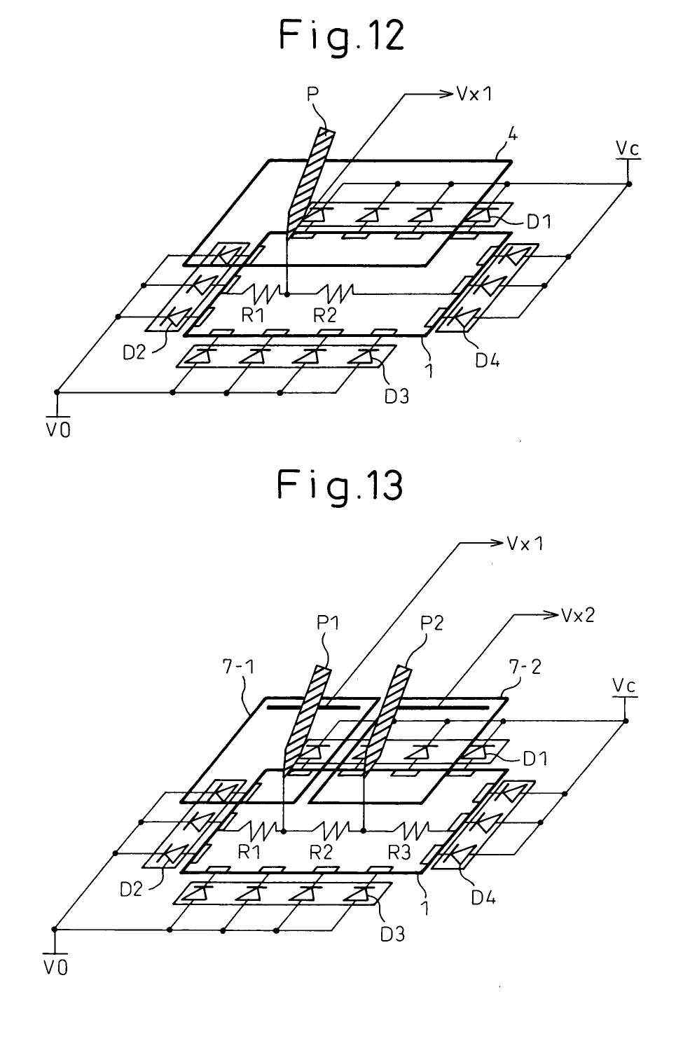

FIG. 12 shows the structure of a resistive-film type touch panel based on the principles of the present invention and adapted to the touch panel in accordance with the fourth embodiment. The resistive touch panel has substrates 1 and 4 opposed to each other. A transparent electrode film is formed on the upper surface of the substrate 1 using an ITO film that is a resistive-film producing a potential gradient. A transparent electrode film that is realized with an ITO film or the like is formed on the undersurface of the substrate 4 made from a transparent resin sheet.

A plurality of electrodes is formed on the edges of the ITO film on the substrate 1. Groups of diodes D1 to D4 are connected to the electrodes formed on the edges of the ITO film. The groups of diodes D1 and D3 are juxtaposed along two opposed edges, and the groups of diodes D2 and D4 are juxtaposed along the other two opposed edges conduct electricity in the same direction.

In the touch panel shown in FIG. 12, the principles of detection of a point on an X axis are presented. A pen P is pressed against or touched to a certain point in a sensing region of the substrate 4, and the substrate 4 touches the ITO film. At this time, first, a voltage Vc is applied to the cathodes of the group of diodes D4, and a ground-level voltage V0 is applied to the anodes of the group of diodes D2. Consequently, a potential gradient is produced to be directed from the group of diodes D4 to the group of diodes D2. A fractional voltage produced by resistors R1 and R2 connected in series with each other in the direction of the X axis is detected as a voltage V1. The detection of the voltage Vx1 determines the point on the X axis.

Thereafter, the groups of diodes to which voltages are applied are changed. The voltage Vc is applied to the cathodes of the group of diodes D3, and the ground-level voltage V0 is applied to the anodes of the group of diodes D1. Consequently, a voltage Vy1 varying in the direction of a Y axis is detected, and a point on the Y axis is identified. Thus, the points on the X and Y axes are identified, and coordinates, representing the position of the pen P in the sensing region, are therefore determined.

According to the fourth embodiment, there is provided the resistive-film type touch panel in which the coordinates representing a position pressed or touched with a pen can be detected. A way of layering a transparent conductive polymer film on a transparent resin sheet adopted as an upper substrate is devised. FIG. 13 shows the structure of the resistive-film type touch panel in accordance with the fourth embodiment. The structure of the resistive type touch panel shown in FIG. 13 is based on the structure of the touch panel shown in FIG. 12. The same reference numerals will be assigned to identical components.

In the resistive-film type touch panel of the fourth embodiment, what is formed on the undersurface of an upper substrate 4, not shown in FIG. 13, is not one transparent conductive polymer film covering all over a sensing region but is a plurality of transparent conductive polymer films. FIG. 13 shows a case where transparent conductive polymer films 7-1 and 7-2 are formed to bisect the sensing region. Two or more transparent conductive polymer films are layered while being separated from each other in the direction of an X or Y axis. Voltage detection electrodes that are independent of each other are formed along one edge of each of the transparent conductive polymer films 7-1 and 7-2 respectively.

As shown in FIG. 13, assuming that two points in the sensing region are pressed or touched with pens P1 and P2 respectively, and that, for example, the transparent conductive polymer film 7-1 is pressed with the pen P1 and the transparent conductive polymer film 7-2 is pressed with the pen P2. In this case, first, a voltage Vc is applied to the cathodes of the group of diodes D4, and a ground-level voltage V0 is applied to the anodes of the group of diodes D2. Consequently, a potential gradient directed from the ground of diodes D4 to the group of diodes D2 is produced. Eventually, voltages Vx1 and Vx2, that are fractional voltages produced by resistors R1, R2, and R3 connected in series with one another in the direction of the X axis, are detected one by one. When the voltages Vx1 and Vx2 are detected, two points on the X axis are identified.

Thereafter, the groups of diodes to which voltages are applied are changed. The voltage Vc is applied to the cathodes of the group of diodes D3, and the ground-level voltage V0 is applied to the anodes of the group of diodes D1. Consequently, voltages Vy1 and Vy2 that are produced in the direction of the Y axis are detected one by one, and two points on the Y axis are identified. Thus, the two points on the X and Y axes are identified, and the coordinates representing the positions in the sensing region pressed with the pens P1 and P2 respectively are determined independently of each other.

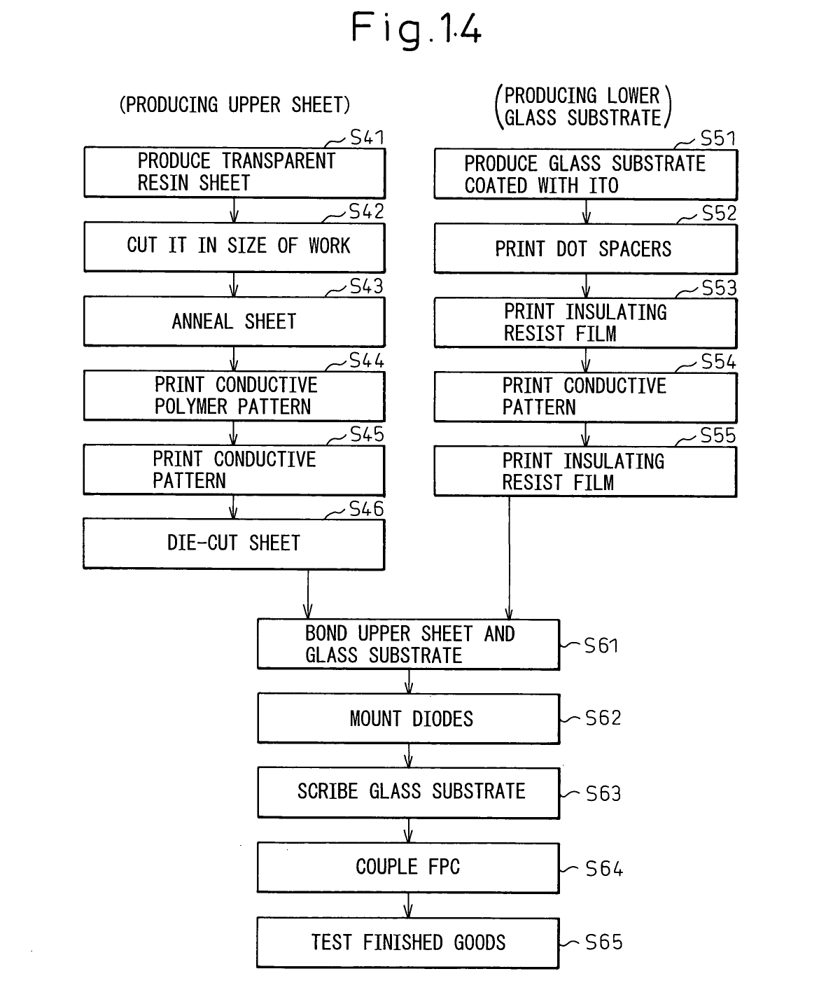

The flowchart of FIG. 14 describes a procedure for manufacturing the resistive-film type touch panel in which when the touch panel is pressed or touched with two pens simultaneously, the coordinates representing the positions are detected independently of each other. In the flowchart, the initial stage is divided into a stage of producing an upper sheet serving as an upper substrate and a stage of producing a lower glass substrate that is a lower substrate. In a final stage, the produced upper and lower substrates are joined to complete a touch panel.

According to the flowchart of FIG. 14, in the stage of producing the upper sheet, first, a transparent resin sheet made of PET, polycarbonate, or cycloolefin is cut in the size of a work that will be provided as an upper substrate (steps S41 and S42), and then annealed (step S43).

Thereafter, a solution in which a transparent conductive polymer is dispersed is applied to predetermined regions of the transparent resin sheet in order to form patterns, which are separated from each other, through screen printing, and then heated and dried. Consequently, transparent conductive polymer films 17-1 and 17-2 are formed (step S44). The step S44 is identical to step S3 of forming a transparent conductive polymer film described in FIG. 2 except that a plurality of patterns is formed through screen printing.

For production of the upper sheet, after the transparent conductive polymer films are formed, a conductive pattern serving as electrodes is formed (step S45). Furthermore, the transparent resin sheet is die-cut (step S46). Thus, the upper sheet is completed.

On the other hand, for production of the lower glass substrate, an ITO film is formed on one side of a glass substrate (step S51). Dot spacers are formed on the ITO film according to a printing technique (step S52). Thereafter, an insulating resist film is formed on the frame-like perimeter of the ITO film (step S53), and a conductive pattern serving as electrodes is formed through screen printing of an Ag paste (step S54).

Similarly to step S53, a frame-like insulating resist film is formed in order to insulate the surface of the conductive pattern (step S55). The lower substrate is then completed. In this stage, the upper and lower substrates are completed. Thereafter, the perimeters of the upper and lower substrates are bonded to each other using a double-sided adhesive tape, which serves as a spacer, so that the transparent conductive polymer film formed on the transparent resin sheet serving as the upper substrate and the ITO film formed on the glass substrate serving as the lower substrate will be opposed to each other (step S61).

Thereafter, groups of diodes D1 to D4 are mounted on the perimeter of the ITO film on the top of the glass substrate (step S62). Thereafter, the glass substrate having the size of a work is scribed so that it will have a predetermined size of a touch panel (step S63). A flexible printed-circuit board is coupled to the electrodes realized with the conductive pattern, whereby a resistive-film type touch panel is completed (step S64). The finished touch panel is tested and then delivered (step S65).

According to the foregoing manufacturing procedure, a transparent electrode film included in a resistive-film type touch panel is layered by applying a solution of a transparent conductive polymer according to a plurality of separate patterns and then heating and drying the solution. A plurality of separate transparent electrode films is readily formed on a transparent resin sheet. Thus, a resistive-film type touch panel enabling concurrent multi-point entry is provided.

When an ITO film is conventionally adopted as an upper transparent electrode film, a step of etching the ITO film is required. According to the fourth embodiment, when the solution of a transparent conductive polymer is applied, a plurality of transparent electrode films is formed according to separate patterns through screen printing. Namely, only the required portions of a substrate are coated with the transparent conductive polymer in order to form the transparent electrode films. Therefore, a step of removing an unnecessary portion of an ITO film so as to divide the ITO film into portions can be omitted. Eventually, the manufacturing process can be simplified.

### Fifth Embodiment

A fifth embodiment is a resistive-film type touch panel employing a transparent resin sheet coated with a transparent conductive polymer whose surface is roughened to have microscopic irregularities. The spacing between upper and lower substrates included in a resistive-film type touch panel is normally equal to or smaller than 10 μm. When the spacing is as narrow as 10 μm or less, interference fringes may be observed on a film due to Newton's rings. According to the fifth embodiment, the surface of a formed transparent conductive polymer film is roughened to have microscopic irregularities in an effort to provide an anti-Newton's rings effect.

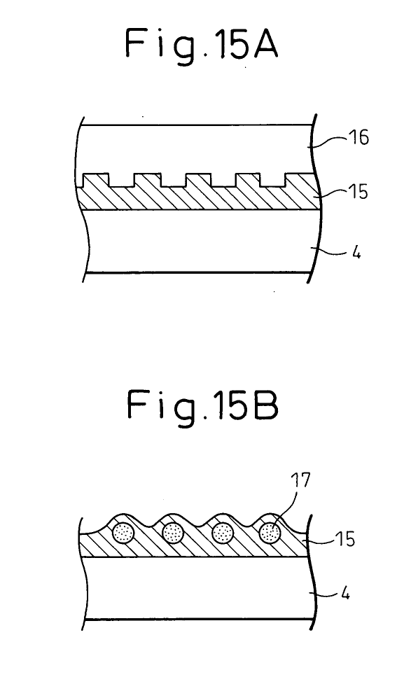

FIG. 15A and FIG. 15B are sectional enlarged views showing the states of a transparent conductive polymer film included in a resistive-film type touch panel in accordance with the fifth embodiment which are attained in the course of manufacture. FIG. 15A and FIG. 15B are concerned with a case where a transparent conductive polymer film is layered on the transparent resin sheet 4 employed in the aforesaid embodiments. FIG. 15A and FIG. 15B show the middle of step S3 of forming a transparent conductive polymer film included in the resistive-film type touch panel manufacturing procedure.

Referring to FIG. 15A, a mold 16 whose surface is machined to have irregularities or to look like a mesh is prepared, and a solution of a transparent conductive polymer is applied to the transparent resin sheet 4. When the solution is heated and dried, the mold 16 is pressed against the surface of the transparent resin sheet 4 to which the solution is applied. When the solution is dried, the mold 16 is peeled off from the applied surface. Consequently, a transparent conductive polymer film 15 whose surface is roughened to have microscopic irregularities is produced.

Referring to FIG. 15B, before a solution of a transparent conductive polymer is applied, inorganic particles having an appropriate diameter, such as particles of silica, are dispersed in the solution. The solution having inorganic particles dispersed therein is applied to the transparent resin sheet 4. Thereafter, when the solution is heated and dried, the solvent is removed to produce a film. At this time, the solution contracts in a depth direction, but the inorganic particles do not contract with heat. The thickness of the portions of a transparent conductive polymer film having the inorganic particles become larger than that of the portions thereof devoid of the inorganic particles. Therefore, if the inorganic particles are appropriately dispersed in a solution, the surface of the transparent conductive polymer film 15, after being dried, has microscopic irregularities.

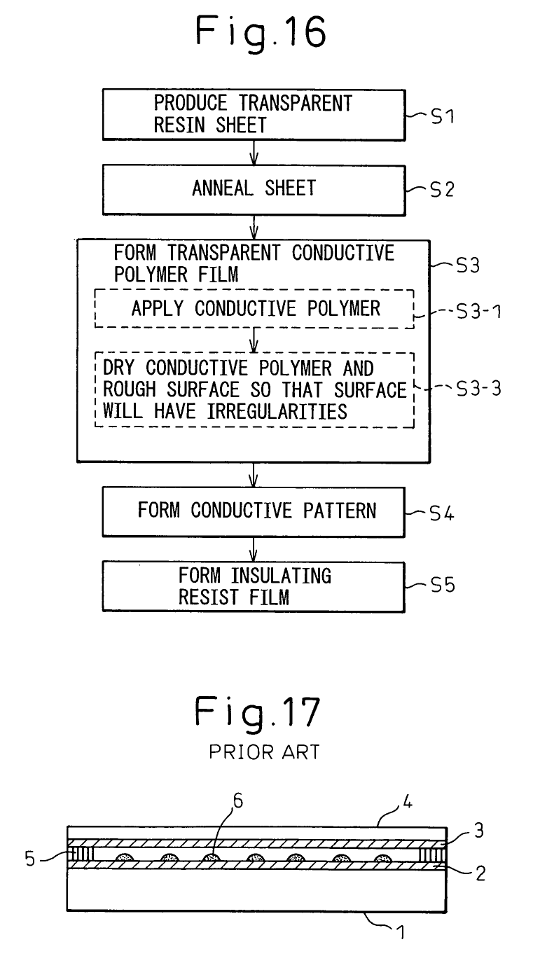

The flowchart of FIG. 16 describes a procedure of manufacturing an upper substrate to be included in the resistive-film type touch panel in accordance with the fifth embodiment. The manufacturing procedure described in FIG. 16 is concerned with a case where a transparent resin sheet is adopted as an upper substrate, and is based on the touch panel manufacturing procedure employed in the first embodiment shown in FIG. 2. The same reference numerals are assigned to the steps of the manufacturing procedure described in FIG. 16 identical to the steps of the manufacturing procedure described in FIG. 2.

In the touch panel manufacturing procedure employed in the fifth embodiment, step S3 of forming a transparent conductive polymer film is different from step S3 described in FIG. 2. Step S3-2 of drying a conductive polymer is replaced by step S3-3 of drying a solution and roughening a surface so that the surface will have irregularities.

When the mould 16 shown in FIG. 15A is used to produce a transparent conductive polymer film whose surface has microscopic irregularities, at step S3-3 of drying a solution and roughing a surface so that the surface will have irregularities, a solution is dried with the mould 16 pressed against the surface of a transparent resin sheet to which the solution is applied. Thereafter, the mold 16 is detached. Consequently, the irregularities or mesh-like pattern of the surface of the mold 16 that is pressed against the surface of the transparent resin sheet is transferred to the surface of a layered transparent conductive polymer film.

As shown in FIG. 15B, when inorganic particles are used to layer a transparent conductive polymer film whose surface has microscopic irregularities, at step 3-1 of applying a conductive polymer, inorganic particles 17 are dispersed in a solution of a conductive polymer. The solution is applied to a transparent resin sheet. At step 3-3 of drying a solution and roughening a surface so that the surface will have irregularities, the applied solution is heated and dried. Consequently, a transparent conductive polymer film is layered. At this time, the surface of the film has irregularities because of the presence of the inorganic particles 17.

As mentioned above, in a resistive-film type touch panel completed by adopting the transparent conductive polymer film formation method employed in the fifth embodiment, the surface of a transparent electrode film is roughened to have microscopic irregularities in order to provide an anti-Newton's rings effect. Therefore, the occurrence of Newton's rings due to a press on or a touch of the touch panel with a pen or the like can be suppressed. Moreover, when the layering method is adopted, a special roughening means need not be prepared separately. The anti-Newton's rings effect can be provided in the course of layering a film.

1. A touch panel having first and second transparent electrode films formed on the internal surfaces of first and second substrates, which are opposed to each other, with a plurality of dot spacers between them, and detecting a change in resistance corresponding to a pressed position, wherein
at least one of said first and second transparent electrode films is formed by coating said substrate with a transparent conductive polymer.

2. A touch panel according to claim 1, wherein said first transparent electrode film is realized with an ITO film, and said second transparent electrode film is formed by coating said second substrate with said transparent conductive polymer.

3. A touch panel according to claim 1, wherein said first and second transparent electrode films are formed by coating said first and second substrates with said transparent conductive polymer.

4. A touch panel according to claim 2, wherein said first substrate is made of a glass, and said second substrate is made from a transparent resin sheet.

5. A touch panel according to claim 2, wherein said first and second substrates are made from transparent resin sheets.

6. A touch panel according to claim 5, wherein a third substrate is bonded to the external surface of said first or second substrate.

7. A touch panel according to claim 1, wherein said first or second transparent electrode film is a transparent conductive polymer film formed all over one surface of said first or second substrate, and electrodes made from a conductive pattern or electrodes realized with a wiring pattern are layered on the perimeter of said transparent conductive polymer film.

8. A touch panel according to claim 1, wherein said first or second transparent electrode film is a transparent conductive polymer film layered all over one surface of said first or second substrate, and electrodes realized with a conductive pattern or electrodes realized with a wiring pattern are layered on the perimeter of one surface of said first or second substrate between said first or second substrate and said transparent conductive polymer film.

9. A touch panel according to claim 1, wherein said first or second transparent electrode film is a laminated body composed of an ITO film and a transparent conductive polymer film.

10. A touch panel according to claim 1, wherein said transparent electrode film formed on at least one of the sides of said first or second substrate includes separate transparent electrode films made from transparent conductive polymer films layered on a plurality of regions, and said electrode films formed on said plurality of regions can mutually independently detect a change in resistance corresponding to a pressed position.

11. A touch panel according to claim 10, wherein said transparent electrode films are separated from one another along one of the surfaces of said first or second substrate.

12. A touch panel according to claim 1, wherein the surface of said transparent conductive polymer film has microscopic irregularities.

13. A touch panel having first and second transparent electrode films formed on the internal surfaces of first and second substrates, which are opposed to each other, with a plurality of dot spacers between them, and detecting a change in resistance corresponding to a pressed position, wherein:
at least one of said first and second transparent electrode films is on pressing side, and the transparent electrode film on pressing side is made from an ITO film; and
a transparent conductive polymer film is layered on the perimeter of said transparent electrode film so that it will have a predetermined width.

14. A touch panel manufacturing method for producing a touch panel which can detect a change in resistance corresponding to a pressed position, by forming first and second transparent electrode films on the internal surfaces of first and second substrates and then opposing said first and second substrates to each other with a plurality of dot spacers between them, wherein:
at least one of said first and second transparent electrode films is layered by applying a transparent conductive polymer, which is dispersed in a solvent, to the surface of said substrate, and then heating and drying the transparent conductive polymer.

15. A touch panel manufacturing method according to claim 14, wherein said first transparent electrode film is formed on the internal surface of said first substrate using an ITO film, and said second transparent electrode film is layered by applying a transparent conductive polymer, which is dispersed in a solvent, to the internal surface of said second substrate, and then heating and drying the transparent conductive polymer.

16. A touch panel manufacturing method according to claim 14, wherein said first transparent electrode film is formed by applying said transparent conductive polymer, which is dispersed in a solvent, to the internal surface of said first substrate, and then heating and drying said transparent conductive polymer material; and said transparent electrode film is layered by applying said transparent conductive polymer, which is dispersed in a solvent, to the internal surface of said second substrate, and then heating and drying said transparent conductive polymer.

17. A touch panel manufacturing method according to claim 15, wherein application of said transparent conductive polymer to said substrate is performed on a predetermined region according to a pattern through printing.

18. A touch panel manufacturing method according to claim 15, wherein said first transparent electrode film is formed on the surface of a glass substrate, and said second transparent electrode film is formed on the surface of a transparent resin sheet.

19. A touch panel manufacturing method according to claim 15, wherein said first and second transparent electrode films are formed on the respective surfaces of transparent resin sheets.

20. A touch panel manufacturing method according to claim 19, wherein said first and second transparent electrode films are layered by applying said transparent conductive polymer, which is dispersed in a solvent, to the surface of a continuous transparent resin sheet, and then heating and drying said transparent conductive polymer; and said transparent resin sheet is folded so that said first and second transparent electrode films will be opposed to each other with said dot spacers between them.

21. A touch panel manufacturing method according to claim 15 wherein, after said first or second transparent electrode film is layered by coating said substrate with said transparent conductive polymer, an electrode pattern or a wiring pattern is formed on the perimeter of said first or second transparent electrode film.

22. A touch panel manufacturing method according to claim 15 wherein, after an electrode pattern or a wiring pattern is formed on the perimeter of said first or second substrate, said first or second transparent electrode film is layered by coating said first or second substrate and said electrode pattern or wiring pattern with said transparent conductive polymer.

23. A touch panel manufacturing method according to claim 15 wherein, after said first or second transparent electrode film is formed by forming an ITO film on the surface of said first or second substrate and then coating said ITO film with said transparent conductive polymer.

24. A touch panel manufacturing method according to claim 15, wherein at least one of said first and second transparent electrode films includes a plurality of separate electrode films formed by applying said transparent conductive polymer to a plurality of regions of said substrate.

25. A touch panel manufacturing method according to claim 15, wherein the surface of said first or second transparent electrode film formed by coating said substrate with said transparent conductive polymer has microscopic irregularities.

26. A touch panel manufacturing method according to claim 25, wherein at least one of said first and second transparent electrode films is layered by applying a transparent conductive polymer, which is dispersed in a solvent, to the surface of said substrate, then heating and drying said transparent conductive polymer with a plate, of which a surface is machined to have irregularities or look like a mesh, superposed on the surface of said substrate to which said transparent conductive polymer is applied, and finally detaching said plate.

27. A touch panel manufacturing method according to claim 25, wherein at least one of said first and second transparent electrode films is layered by applying a transparent conductive polymer and inorganic particles, which are dispersed in a solvent, to the surface of said substrate, and then heating and drying said transparent conductive polymer and inorganic particles, so that the surface of said electrode film will have microscopic irregularities.

28. A touch panel manufacturing method for producing a touch panel, which can detect a change in resistance corresponding to a pressed position, by forming first and second transparent electrode films on the internal surfaces of first and second substrates, and then opposing said first and second substrates to each other with a plurality of dot spacers between them, wherein:
at least one of said first and second transparent electrode films is formed on said substrate using an ITO film; and
after a transparent conductive polymer dispersed in a solvent is applied to the edges of said touch panel that have a predetermined width, that is, to the perimeter of said ITO film, said transparent conductive polymer is heated and dried.

29. A touch panel manufacturing method according claim 16 wherein, after said first or second transparent electrode film is formed by forming an ITO film on the surface of said first or second substrate and then coating said ITO film with said transparent conductive polymer.

30. A touch panel manufacturing method according claim 17 wherein, after said first or second transparent electrode film is formed by forming an ITO film on the surface of said first or second substrate and then coating said ITO film with said transparent conductive polymer.

31. A touch panel manufacturing method according claim 18 wherein, after said first or second transparent electrode film is formed by forming an ITO film on the surface of said first or second substrate and then coating said ITO film with said transparent conductive polymer.

32. A touch panel manufacturing method according claim 19 wherein, after said first or second transparent electrode film is formed by forming an ITO film on the surface of said first or second substrate and then coating said ITO film with said transparent conductive polymer.

33. A touch panel manufacturing method according claim 20 wherein, after said first or second transparent electrode film is formed by forming an ITO film on the surface of said first or second substrate and then coating said ITO film with said transparent conductive polymer.
